(19) United States
(12) Patent Application Publication
(10) Pub. No.: US 2022/0083507 A1
(43) Pub. Date: Mar. 17, 2022

(54) TRUST CHAIN FOR OFFICIAL DATA AND DOCUMENTS

(71) Applicant: Sheryl Crowell, Newport News, VA (US)

(72) Inventor: Sheryl Crowell, Newport News, VA (US)

(21) Appl. No.: 17/019,345

(22) Filed: Sep. 13, 2020

(51) Int. Cl. G06F 16/13; G06F 16/14; H04L 9/32

(52) U.S. Cl. CPC G06F 16/137; H04L 2209/38; H04L 9/3236; G06F 16/152

(57) ABSTRACT

A system and method providing blockchain data storage of official records and documents is disclosed. The system includes a plurality of trusted blockchain processors commutatively connected over the Internet, one or more document servers for maintaining copies of documents and data commutatively connected to the plurality of trusted blockchain processors, and data storage coupled to the one or more document servers for storing documents, data, and hash values associated with the documents and data.

### TECHNICAL FIELD

This application relates in general to a system and method for providing secure data and document storage, and more specifically, to a system and method providing blockchain data storage and transmission of official records and documents.

### BACKGROUND

Creating accurate and trusted governmental documents and data that may be maintained, trusted and used over a long period of time has been a challenge to societies since the beginning of recorded time. Storing the data and documents in one or more locations such that a copy of the data is available is typically used. These documents and data are marked with a seal or similar indication that the documents are original and were marked by a trusted government official with an accurate date of marking when these records were maintained in written form. The expectation that written documents will be identifiable as having been altered thus permitting them to be trusted.

Currently, most documents and data are stored for archival purposed in digital form. Signed documents may be scanned, and an image of the printed document may be retained. These documents may be marked with a seal to identify them as being seen by an official on a date certain before scanning. The use of digital storage has reduced the volume of storage space needed for these records and has significantly reduced the time and effort to retrieve stored data. With these benefits, the documents may be more easily altered and falsely created. This digital altering of these records presents a significant problem in maintaining a level of trust that documents and data retrieved from storage is difficult.

Therefore, a need exists for a system and method for providing secure data and document storage and transmission, and more specifically, to a system and method providing blockchain data storage and transmission of official records and documents. The system and method provides real-time secure data storage and transmission between various levels of government as well as secure archival and retrieval of documents and data. The present invention attempts to address limitations and deficiencies of current solutions according to principles and example embodiments disclosed herein.

### SUMMARY

In accordance with the present invention, the above and other problems are solved by providing a system and method for providing blockchain data storage of official records and documents according to the principles and example embodiments disclosed herein.

In one embodiment, the present invention is a system for providing blockchain data storage and transmission of official records and documents. The system includes a plurality of trusted blockchain processors commutatively connected over the Internet, one or more document servers for maintaining copies of documents and data commutatively connected to the plurality of trusted blockchain processors, and data storage coupled to the one or more document servers for storing documents, data, and hash values associated with the documents and data.

In another aspect of the present disclosure, the one or more one or more document servers includes a memory having instructions stored thereon and a processor configured to execute the instructions on the memory to cause the document servers to receive a digital representation of documents and data for secure storage and transmission, transmit a copy of the digital representation of documents and data to the plurality of trusted blockchain processors, calculate a new hash value associated with the digital representation of documents and data and a last generated hash value from a previous block of data stored into the data storage, when the new hash value matches a new blockchain hash value generated by a majority of the plurality of block chain processors, store the digital representation of the documents and data along with the new hash value into a block data in the data storage. The new hash value is used as the last generated hash value for a next block of data and documents to be stored once the digital representation of the documents and data are stored into the data storage.

In yet another aspect of the present disclosure the one or more document servers further executed instructions causing the document servers to receive a request to retrieve a previously stored block of data, retrieve the previously stored block of data from the data storage, parse the digital representation of the documents and data and the stored hash value associated with the previously stored block, transmit the previously stored block of data to the plurality of blockchain processors for generating a retrieved hash value using the documents and data and the last generated hash value from storage in each of the plurality of blockchain processors used when the retrieved block of data was stored, generate newly generated has value using the documents and data and the last generated hash value from the previous block of data stored immediately before the retrieved block of data was stored, and indicate that the digital representation of the documents and data from the retrieved block of data when the newly generated hash value, the stored hash value, and a majority of retrieved hash values from the plurality of blockchain processors.

In another aspect of the present invention, the plurality of blockchain processors including a memory having instructions stored thereon, and a processor configured to execute the instructions on the memory to cause the document servers to: receive the digital representation of the documents and data, retrieve a last generated blockchain hash value form its local storage, generate a new blockchain hash value using the digital representation of the documents and data and the last generated blockchain hash value, and store the new blockchain hash value onto the local storage and set it as the last generated blockchain hash value when the new blockchain hash value matches the new hash value generated by the document server and a majority of new blockchain hash values from the other blockchain processor.

In yet another aspect of the present invention, the processors of the plurality of blockchain processors further cause them to receive, from the document servers, a previously stored block of data by each of the plurality of blockchain processors for generating a retrieved hash value using the documents and data and the last generated hash value from storage in each of the plurality of blockchain processors used when the retrieved block of data was stored, and retrieve the stored hash value associated with the retrieved block of data block of data and the stored last used hash value used in generating its hash value from local data storage.

In another embodiment, the present invention is a method for providing blockchain data storage and transmission of official records and documents, the method receives a digital representation of documents and data for secure storage and transmission, transmits a copy of the digital representation of documents and data to the plurality of trusted blockchain processors, calculates a new hash value associated with the digital representation of documents and data and a last generated hash value from a previous block of data stored into the data storage, and when the new hash value matches a new blockchain hash value generated by a majority of the plurality of block chain processors, stores the digital representation of the documents and data along with the new hash value into a block data in the data storage. The new hash value is used as the last generated hash value for a next block of data and documents to be stored once the digital representation of the documents and data are stored into the data storage.

in another aspect of the present disclosure, the method further receives a request to retrieve a previously stored block of data by one or more of the document servers, retrieves the previously stored block of data from the data storage by one or more of the document servers, parses the digital representation of the documents and data and the stored hash value associated with the previously stored block by one or more of the document servers, transmits the previously stored block of data to the plurality of blockchain processors for generating a retrieved hash value using the documents and data and the last generated hash value from storage in each of the plurality of blockchain processors used when the retrieved block of data was stored by one or more of the document servers, generates, by one or more of the document servers, a newly generated has value using the documents and data and the last generated hash value from the previous block of data stored immediately before the retrieved block of data was stored, and indicates, by one or more of the document servers, that the digital representation of the documents and data from the retrieved block of data when the newly generated hash value, the stored hash value, and a majority of retrieved hash values from the plurality of blockchain processors.

In yet another aspect of the present invention, the method receives, by the plurality of blockchain processors, the digital representation of the documents and data retrieves a last generated blockchain hash value form its local storage by the plurality of blockchain processors, generates a new blockchain hash value using the digital representation of the documents and data and the last generated blockchain hash value by the plurality of blockchain processors, and stores the new blockchain hash value onto the local storage and set it as the last generated blockchain hash value when the new blockchain hash value matches the new hash value generated by the document server and a majority of new blockchain hash values from the other blockchain processor.

In yet another aspect of the present invention, the method receivies, from the document servers, a previously stored block of data by each of the plurality of blockchain processors for generating a retrieved hash value using the documents and data and the last generated hash value from storage in each of the plurality of blockchain processors used when the retrieved block of data was stored, and retrieves the stored hash value associated with the retrieved block of data block of data and the stored last used hash value used in generating its hash value from local data storage.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1a illustrates a prior art example embodiment for a blockchain.

FIG. 1b illustrates an example embodiment for a processing system that provides blockchain data storage and transmission of official records and documents according to the present invention.

FIG. 2a is a block diagram illustrating an exemplary hardware architecture of a computing device.

FIG. 2b is a block diagram illustrating an exemplary logical architecture for a client device.

FIG. 2c is a block diagram showing an exemplary architectural arrangement of clients, servers, and external services.

FIG. 2d is another block diagram illustrating an exemplary hardware architecture of a computing device.

FIG. 3 illustrates an example embodiment of a document and information data flow in a system providing blockchain data storage and transmission of official records and documents according to the present invention.

FIG. 4 illustrates an example embodiment of a document and information data flow in a system providing blockchain data storage and transmission of official records and documents according to the present invention.

FIG. 5 illustrates a computing system of software components providing blockchain data retrieval of official records and documents according to the present invention. according to the present invention.

FIG. 6 illustrates a data flow and interconnected blockchain corresponding to software components system providing blockchain data retrieval of official records and documents according to the present invention.

FIG. 7 illustrates a flowchart corresponding to a method performed by a software components in a system providing blockchain data retrieval of official records and documents according to the present invention.

### DETAILED DESCRIPTION

This application relates in general to a system and method for providing secure data and document storage and transmission, and more specifically, to a system and method providing blockchain data storage and transmission of official records and documents according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member [symbol] contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “50-250 micrometers” should be interpreted to include not only the explicitly recited values of about 50 micrometers and 250 micrometers, but also include individual values and sub-ranges within the indicated range. Thus, included in this numerical range are individual values such as 60, 70, and 80 micrometers, and sub-ranges such as from 50-100 micrometers, from 100-200, and from 100-250 micrometers, etc.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specifications and claims are approximations that may vary depending upon the desired properties sought to be obtained by the present disclosure. At the very least, and not as an attempt to limit the application of the doctrine of equivalents to the scope of the claims, each numerical parameter should be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly,” consistent with the discussion above regarding ranges and numerical data.

The term “mobile application” refers to an application executing on a mobile device such as a smartphone, tablet, and/or web browser on any computing device.

The terms “individual” and “user” refer to an entity, e.g. a human, using the Trust Chain for Official Data and Document system including any software or smart device application(s) associated with the invention. The term user herein refers to one or more users.

The term “connection” refers to connecting any component as defined below by any means, including but not limited to, a wired connection(s) using any type of wire or cable for example, including but not limited to, coaxial cable(s), fiberoptic cable(s), ethernet cable(s) or wireless connection(s) using any type of frequency/frequencies or radio wave(s). Some examples are including below in this application.

The term “invention” or “present invention” refers to the invention being applied for via the patent application with the title “Trust Chain for Official Data and Documents.” Invention may be used interchangeably with official data chain.

The terms “communicate,” “communication” or “communications” refer to any component(s) connecting with any other component(s) in any combination for the purpose of the connected components to communicate and/or transfer data to and from any components and/or control any settings.

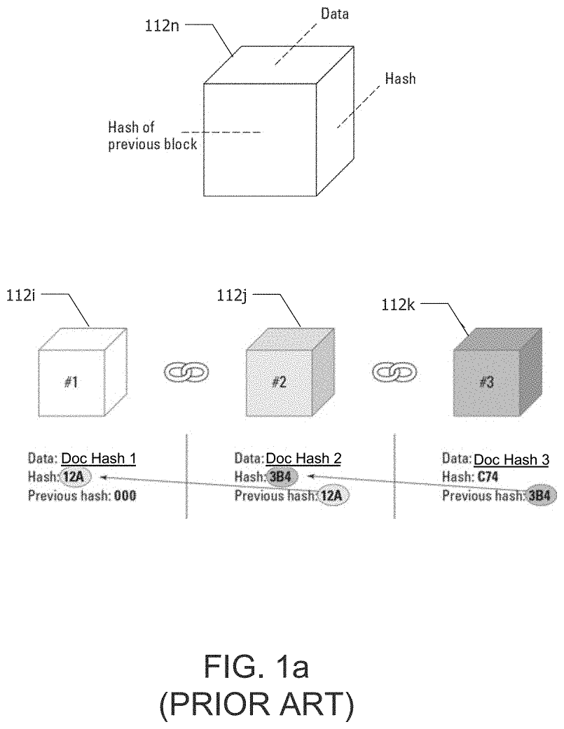

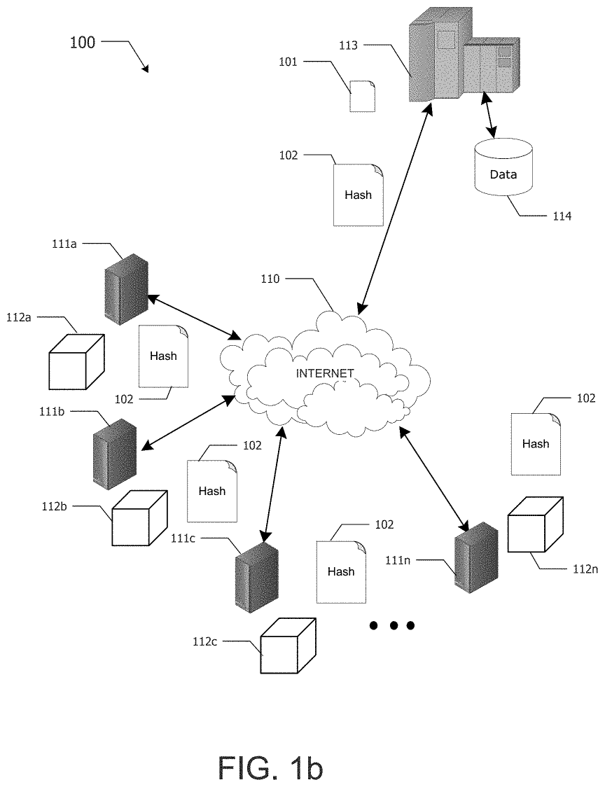

In general, the present disclosure relates to a system and method for providing secure data storage and transmission. To better understand the present invention, FIG. 1a illustrates a prior art example embodiment of a blockchain. A blockchain is a special kind of database. The term blockchain refers to an entire network of distributed ledger technologies. A ledger is typically viewed as a book or other collection of records of a particular type. It may be a computer file that records transactions. A ledger is actually the foundation of accounting and is as old as writing and money.

A blockchain refers to an entire suite of incorruptible digital ledgers of economic transactions and otherwise important data that can be programmed to record and track not only financial transactions, but also copies of important and historical documents. It is a shared, distributed, and immutable ledger that records the history of transactions starting with transaction number one. It establishes trust, accountability, and transparency.

A blockchain 112 stores information in batches called blocks. These blocks are linked together in a sequential way to form a continuous line, i.e. a chain of blocks 112. Each block is like a page of a ledger or a record book. Each block mainly has three elements: data, a hash value, and a previous hash value.

The type of data depends on what the blockchain is being used to store. In use by the present invention, a block's data contains the details of official data and documents plus identities of trusted individuals adding the data and documents to the blockchain 112. A hash in a blockchain is something like a unique identifier, similar to a fingerprint or signature. It identifies a block and all its content and is generated based upon the contents of the block being added to the blockchain 112. Because each block carries the hash value of the previous block and because the new hash value is based upon the data and the previous hash value, the new hash value, and thus the entire chain of blocks, becomes very secure. Any changes made to the underlying document would generate a different hash value. Without access to the previous block's hash value, an updated hash value cannot be recreated.

Additionally a change to a hash value in one block of the chain causes all of the subsequent blocks to require updates to their corresponding hash values. Thus, it will be difficult, if not impossible to change the content of a block of data in the chain of blocks without the change being discovered.

A blockchain node processor 111 is one of multiple distributed computing devices that are located in many locations and each blockchain node processor 111 generates its own copy of the blockchain 112. Before a new block of data is added to the blockchain 112, each of the blockchain node processors 111 receives a copy of the new data block, retrieves the hash value from the last block in their local copy of the blockchain 112, and compares the new hash value with other blockchain node processors 111. The new block is added to the blockchain 112 only after all of the blockchain node processors 111 agree that the new hash values match. Typically, the block is added to the blockchain 112 when a threshold number of blockchain node processors 111 agree on the new hash value. If a particular blockchain node processor 111 does not generate the agreed upon hash value, then either their copy of the data in the new block differs from the data stored onto all of the other blockchain node processors' 111 copy of the blockchain 112 or the data in the blockchain 112 having the discrepancy has been changed. This particular blockchain node processor 111 no longer has an accurate copy of the ledger. Therefore, an alteration of the contents of a block on a blockchain 112, even if the downstream blocks of data have their hash values updated by someone altering the official record, needs to simultaneously occur on all of the blockchain node processors 111 in a blockchain 112 in order for the alteration of the data to occur unnoticed.

FIG. 1b illustrates an example embodiment of a processing system that provides blockchain data storage of official records and documents according to the present invention. A secure data storage system 100 uses a blockchain 112 to create and maintain an official record of information for the operator of the secure data storage system 100. One possible use of the secure data storage system 100 would be to maintain a secure record of all financial transactions with a governmental entity. These public records need to be secure and trusted if the records are to provide a useful set of data for everyone to rely upon. For example, a local government may create a blockchain 112 containing all of the tax payments made by its citizens and businesses operating or living in the city. If all of the payments received by the local government are added to the blockchain 112, the citizens and the government may trust that any entry on the blockchain 112 is accurate.

Local governments also retain copies of documents for later use that require a similar level of trust. A set of land ownership records that is typically maintained by a city or county maintains a copy of all of the deeds and related ownership and lien records for all of the land transactions in the local jurisdiction from the start of the recording of the records, which typically dates back to the creation of the local government, through to the present day. Using a search of these records for transactions related to a particular piece of land generates a chain of ownership from the present time to the first recorded owner. Alterations of a record in the middle of that chain of title causes current ownership of the land found in these records to be in question. Digitally storing all of these land records in a land records blockchain 112 will provide confidence that the records are the original and unaltered copy of the data since it was recorded.

A blockchain 112 may store any type or amount of data within each data block in the blockchain 112. If the documents to be protected are stored in their entirety within the blockchain 112, the amount of storage required by each of the copies of the blockchain 112 located within each of the blockchain node processors 111 will be significant. The generation of a new hash value based upon the contents of the new data block requires significantly more calculations as the size of the data blocks grow. As such, typically a secure data storage system 100 sets a practical limit to the size of the data blocks contained in a blockchain 112.

If a governmental organization maintaining the official land records accepts the cost to maintain multiple copies of the blockchain 112 on a set of blockchain node processors 111a-n that contain entire documents, and if the users of the governmental organization's records accept any latency in the secure data storage system 100 storing and retrieving a document from the blockchain 112, digital copies of the documents being stored may be scanned, compressed, and added to a data block in the blockchain 112.

If, however, the governmental organization wishes to utilize the benefits of use of a blockchain 112 while maintaining smaller storage requirements for the blockchain node processors 111a-n, the governmental organization may use a hybrid records system according to the present invention. In such a system, an official document server 113 may be used to retain a complete digital copy of the official documents and data. The official document server 113 may use well known backup and disaster recovery processes to ensure that a complete copy of an official document database 114 is available for use.

In addition to the use of the official document server 113 maintaining the official document database 114, a blockchain 112 is created and distributed over a set of blockchain node processors 111a-n, each of which maintains a local copy of the blockchain 112a-n, that verifies that a document retrieved from the official document database 114 has not been altered. Within each block of the blockchain 112, a digital representation of one or more digital documents may be included. These digital representations of one or more digital documents will store a set of metadata that identifies the official document 101 being added to the official document database 114, identity information of the person adding the official document 101 to the official document database 114, identities of any relevant parties referenced or named in the official document 101, and possibly smaller image segments documenting important parts associated with these documents, such as signatures and other marks of importance. These sets of meta data for each official document 101 recorded in the official document database 114, significantly reduces the amount of data that is stored within the blockchain 112. The official documents 101 are protected from alternation by also including within the set of metadata stored in the blockchain 112 a hash value of the entire official document 101 that is stored in the official document database 114. The hash value for the entire digital document may be calculated at a later date when the official document 101 is retrieved from the official document database 114. The hash value for the entire digital document also may be retrieved from the blockchain 112. The new hash value and the retrieved hash value should match if the digital representation of the official document 101 has not changed from the time it was added to the official document database 114. In some embodiments, a copy of the hash value associated with the official document 101 that was stored into the blockchain 112 also may be stored in the official document database 114 along with the official document 101 or within metadata of the official document 101. This hash value extracted from the digital representation of the official document 101 retrieved from the official document database 114 should also match the hash values calculated when the official document 101 is retrieved from the official document database 114 as well as match the hash value extracted from the blockchain 112.

While the above example explains the present invention in terms of a governmental organization maintaining digital representation of official documents 101, the above secure data storage system 100 may be used by any entity that wishes to maintain a secure, trusted, and permanent record of important information. The above examples also use official documents 101 to define the important data to be secured by the secure data storage system 100. Other data such as images, videos, historical documents and texts, and data of any kind may be used in place of an official document 101 as disclosed herein. The use of these examples are not intended to limit the scope of the present invention that is solely defined in the attached claims.

The present invention may be used for all civilian governmental purposes to store, preserve, and authenticate data and documents. Basically, a blockchain-based secure data storage system 100 provides a secure record of government transactions possible. Some transactions would be made visible to the public while others would only be shared among government employees.

The invention may use any type of network such as a single network, multiple networks of a same type, or multiple networks of different types which may include one or more of a direct connection between devices, including but not limited to a local area network (LAN), a wide area network (WAN) (for example, the Internet), a metropolitan area network (MAN), a wireless network (for example, a general packet radio service (GPRS) network), a long term evolution (LTE) network, a telephone network (for example, a Public Switched Telephone Network or a cellular network), a subset of the Internet, an ad hoc network, a fiber optic network (for example, a fiber optic service (often known as FiOS) network), or any combination of the above networks.

Smart devices mentioned herein the present application may also use one or more sensors to receive or send signals, such as wireless signals for example, Bluetooth™, wireless fidelity, infrared, Wi-Fi, or LTE. Any smart device mentioned in this application may be connected to any other component or smart device via wired communications (e.g., conductive wire, coaxial cable, fiber optic cable, ethernet cable, twisted pair cable, transmission line, waveguide, etc.), or a combination of wired and wireless communications. The invention's method and/or system may use a single server device or a collection of multiple server devices and/or computer systems.

The systems and methods described above, may be implemented in many different forms of applications, software, firmware, and hardware. The actual software or smart device application codes or specialized control software, hardware or smart device application(s) used to implement the invention's systems and methods is not limiting of the implementation. Thus, the operation and behavior of the systems and methods were described without reference to the specific software or firmware code. Software, smart device application(s), firmware, and control hardware can be designed to implement the systems and methods based on the description herein.

While all of the above functions are described to be provided to users via a mobile application on a smartphone, one of ordinary skill will recognize that any computing device including tablets, laptops, and general purpose computing devices may be used as well. In at least one embodiment, all of the services described herein are provided using web pages being accessed from the web server 201 using a web browser such as Safari™, Firefox™, Chrome™ DuckDuckGo™, and the like. All of the screen examples described herein show user interface elements that provide the functionality of the present invention. The arrangement, organization, presentation, and use of particular user input/output (I/O) elements including hyperlinks, buttons, text fields, scrolling lists, and similar I/O elements are shown herein for example embodiments only to more easily convey the features of the present invention. The scope of the present invention should not be interpreted as being limited by any of these elements unless expressly recited within the attached claims.

For the purposes of the example embodiment of FIG. 1, various functions are shown to be performed on different programmable computing devices that communicate with each other over the Internet 105. These computing devices may include smartphones 101a, laptop computers 101b, tablets (not shown), and similar devices so long as the disclosed functionality of the mobile application described herein is supported by the particular computing device. One of ordinary skill will recognize that this functionality is grouped as shown in the embodiment for clarity of description. Two or more of the processing functions may be combined onto a single processing machine. Additionally, it may be possible to move a subset of processing from one of the processing systems shown here and retain the functionality of the present invention. The attached claims recite any required combination of functionality onto a single machine, if required, and all example embodiments are for descriptive purposes.

For all of the above devices that are in communication with each other, some or all of them need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects, and in order to more fully illustrate one or more aspects. Similarly, although process steps, method steps, algorithms or the like may be described in a sequential order, such processes, methods, and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method or algorithm is carried out or executed. Some steps may be omitted in some aspect or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example, an end-user computer system, a client computer, a network server or other server system, a mobile computing device (e.g., tablet computing device, mobile phone, smartphone, laptop or other appropriate computing device), a consumer electronic device, a music player or any other suitable electronic device, router, switch or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines or other appropriate virtual environments).

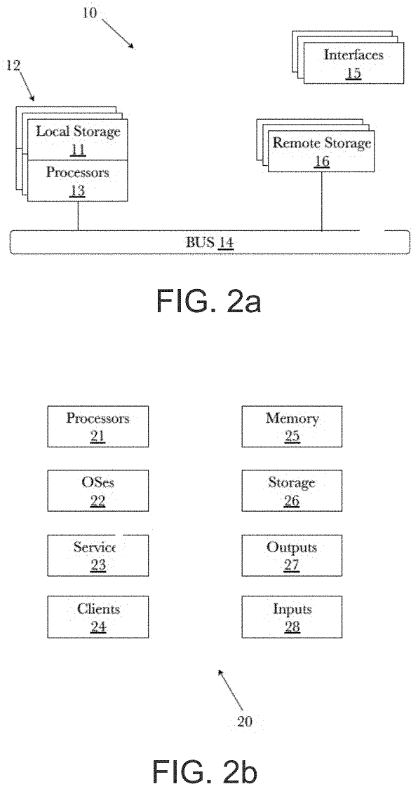

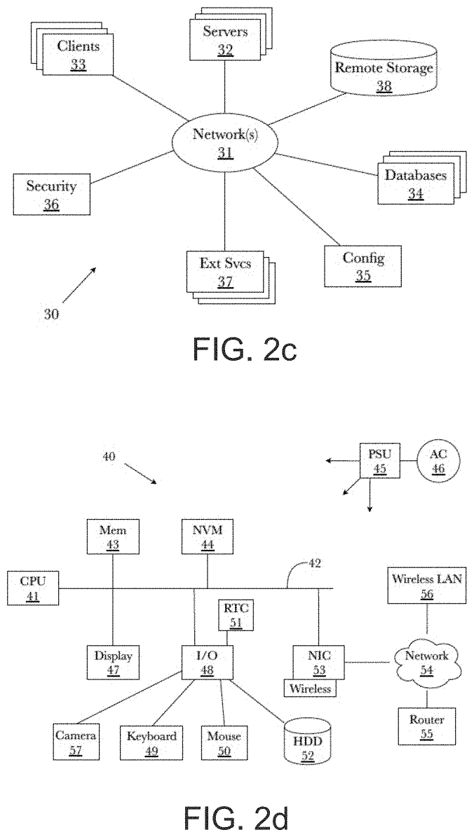

Referring now to FIG. 2a, there is a block diagram depicting an exemplary computing device 10 suitable for implementing at least a portion of the features or functionalities disclosed herein. A computing device 10 may be, for example, any one of the computing machines listed in the previous paragraph, or indeed any other electronic device capable of executing software- or hardware-based instructions according to one or more programs stored in memory. A computing device 10 may be configured to communicate with a plurality of other computing devices, such as clients or servers, over communications networks such as a wide area network, a metropolitan area network, a local area network, a wireless network, the Internet or any other network, using known protocols for such communication, whether wireless or wired.

In one aspect, a computing device 10 includes one or more central processing units (CPUs) 12, one or more interfaces 15, and one or more buses 14 (such as a peripheral component interconnect (PCI) bus). When acting under the control of appropriate software or firmware, the CPU 12 may be responsible for implementing specific functions associated with the functions of a specifically configured computing device or machine. For example, in at least one aspect, a computing device 10 may be configured or designed to function as a server system utilizing a CPU 12, local memory 11 and/or remote memory 16, and interface(s) 15. In at least one aspect, a CPU 12 may be caused to perform one or more of the different types of functions and/or operations under the control of software modules or components, which for example, may include an operating system and any appropriate applications software, drivers, and the like.

A CPU 12 may include one or more processors 13 such as for example, a processor from one of the Intel, ARM, Qualcomm, and AMD families of microprocessors. In some aspect, processors 13 may include specially designed hardware such as application-specific integrated circuits (ASICs), electrically erasable programmable read-only memories (EEPROMs), field-programmable gate arrays (FPGAs), and so forth, for controlling operations of a computing device 10. In a particular aspect, a local memory 11 (such as non-volatile random access memory (RAM) and/or read-only memory (ROM), including for example, one or more levels of cached memory) may also form part of a CPU 12. However, there are many different ways in which memory may be coupled to a system 10. Memory 11 may be used for a variety of purposes such as, for example, caching and/or storing data, programming instructions, and the like. It should be further appreciated that a CPU 12 may be one of a variety of system-on-a-chip-(SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may, for example, support other peripherals used with a computing device 10. Among the interfaces that may be provided are ethernet interfaces, frame relay interfaces, cable interfaces, DSL interfaces, token ring interfaces, graphics interfaces, and the like. In addition, various types of interfaces may be provided such as, for example, universal serial bus (USB), serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast ethernet interfaces, gigabit ethernet interfaces, serial ATA (SATA) or external SATA (ESATA) interfaces, high-definition multimedia interfaces (HDMI), digital visual interfaces (DVI), analog or digital audio interfaces, asynchronous transfer mode (ATM) interfaces, high-speed serial interfaces (HSSI), point of sale (POS) interfaces, fiber data distributed interfaces (FDDis), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 2a illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and a server system (such as a server system described in more detail below).

Regardless of network device configuration, the system of an aspect may employ one or more memories or memory modules (for example, remote memory block 16 and local memory 11) configured to store data, program instructions for the general-purpose network operations or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information or any other specific or generic non-program information described herein.

Because such information and program instructions may be employed to implement one or more systems or methods described herein, at least some network device aspects may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device) or they may be removable such as swappable flash memory modules (such as “thumb drives” or other removable media designed for rapidly exchanging physical storage devices), “hot-swappable” hard disk drives or solid state drives, removable optical storage disks, or other such removable media, and that such integral and removable storage media may be utilized interchangeably. Examples of program instructions include both object code, such as may be produced by a compiler, machine code, such as may be produced by an assembler or a linker, byte code, such as may be generated by for example by a JAVA™ compiler and may be executed using a JAVA™ virtual machine or equivalent, or files containing higher level code that may be executed by the computer using an interpreter (for example, scripts written in Python™, Perl™, Ruby™, Groovy™, or any other scripting language).

In some aspects, systems may be implemented on a standalone computing system. Referring now to FIG. 2b, there is a block diagram depicting a typical exemplary architecture of one or more aspects or components thereof on a standalone computing system. A computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the LINUX™ operating system, ANDROID™ operating system, or the like. In many cases, one or more shared services 23 may be operable in system 20, and may be useful for providing common services to client applications 24. Services 23 may, for example, be WINDOWS™ services, user-space common services in a LINUX™ environment or any other type of common service architecture used with an operating system 21. Input devices 28 may be of any type suitable for receiving user input including, for example, a keyboard, touchscreen, microphone (for example, for voice input), mouse, touchpad, trackball or any combination thereof. Output devices 27 may be of any type suitable for providing output to one or more users, whether remote or local to system 20, and may include, for example, one or more screens for visual output, speakers, printers or any combination thereof. Memory 25 may be RAM having any structure and architecture known in the art for use by processors 21, for example to run software. Storage devices 26 may be any magnetic, optical, mechanical, memristor or electrical storage device for storage of data in digital form (such as those described above, referring to FIG. 2a). Examples of storage devices 26 include flash memory, magnetic hard drive, CD-ROM, and the like.

In some aspects, systems may be implemented on a distributed computing network, such as one having any number of clients and/or servers. Referring now to FIG. 2c, there is a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. B. In addition, any number of servers 32 may be provided for handling requests received from one or more clients 33. Clients 33 and servers 32 may communicate with one another via one or more electronic networks 31, which may be in various aspects any Internet, wide area network, mobile telephony network (such as CDMA or GSM cellular networks), wireless network (such as WiFi, WiMAX, LTE, and so forth) or local area network (or indeed any network topology known in the art; the aspect does not prefer any one network topology over another). Networks 31 may be implemented using any known network protocols, including, for example, wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself For example, in one aspect where client applications 24 are implemented on a smartphone or other electronic device, client applications 24 may obtain information stored on a server system 32 in the Cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and use a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web system. It should be understood by one having ordinary skill in the art that any configuration or security subsystems known in the art now or in the future may be used in conjunction with aspects without limitation, unless a specific security 36 or configuration system 35 or approach is required by the description of any specific aspect.

FIG. 2d shows an exemplary overview of a computer system 40 as may be used in any of the various locations throughout the system. It is exemplary of any computer that may execute code to process data. Various modifications and changes may be made to a computer system 40 without departing from the broader scope of the system and method disclosed herein. A CPU 41 is connected to bus 42, to which bus is also connected to memory 43, nonvolatile memory 44, display 47, I/O unit 48, and network interface card (NIC) 53. An I/O unit 48 may, typically, be connected to peripherals such as a keyboard 49, pointing device 50, hard disk 52, real-time clock 51, camera 57, and other peripheral devices. A NIC 53 connects to a network 54, which may be the Internet or a local network, which local network may or may not have connections to the Internet. The system may be connected to other computing devices through the network via a router 55, wireless local area network 56 or any other network connection. Also shown as part of a system 40 is a power supply unit 45 connected, in this example, to a main alternating current (AC) supply 46. Not shown are batteries that could be present and many other devices and modifications that are well known, but are not applicable to, the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles or other integrated hardware devices).

In various aspects, functionality for implementing systems or methods of various aspects may be distributed among any number of client and/or server components. For example, various software modules may be implemented for performing various functions in connection with the system of any particular aspect, and such modules may be implemented to run on server and/or client components.

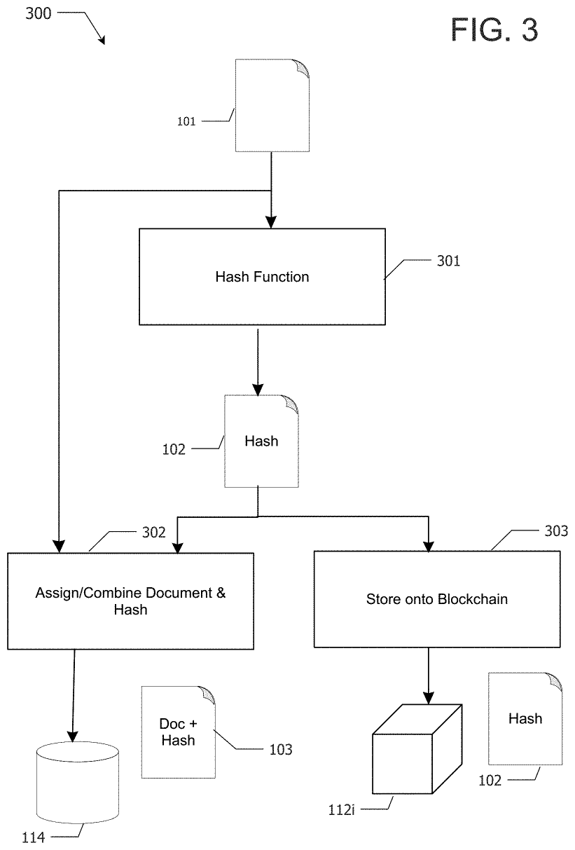

FIG. 3 illustrates an example embodiment of a document and information data flow in a system providing blockchain data storage and transmission of official records and documents according to the present invention. The process begins when an official document 101 is received by the official document server 113 for inclusion into the official document database 114. The digital representation of the official document 101 is typically a scanned image of a document or similar data file. A hash function 301 is applied to the digital representation of the official document 101 to generate a hash value of the official document 102. In a preferred embodiment, Any hash function can be used in the above functions. In a preferred embodiment, Ethereum may be used to create the proof of stake from Proof of Work. While Ethereum is moving into version ETH 2.0, the present invention may also utilize Ethereum 1.0 as well as other functions.

The hash of the official document I 02 is passed to a combined document and hash function 302 as well as to a store hash into the blockchain function 303. The combined document and hash function 302 also receive the official document 101 that is uploaded for insertion into the official document database 114. The combined document and hash function 302 combines the official document 101 and the hash of the official document 102 for storage as a data record in the official document database 114. As noted above, the combination of the official document 101 and hash of the official document 102 may be accomplished by combining them into a single file, by adding the hash of the official document I 02 to any metadata associated with the official document IO I or by storing each in a separate file of a database record stored in the official document database 114. This combination of data is stored in the official document database 114 as an official document 101.

The hash of the official document I 02 also is sent for insertion into the blockchain 112 by the store hash into the blockchain function 303. This hash value is to be included within a data block of the blockchain 112 by each of the blockchain node processors 111. The hash of the official document I 02 typically is accompanied by a set of identifying data as described above in reference to FIG. 1b. The set of identifying data includes at least a unique identifier such as a unique database key associated with the database record containing the official document 101 in the official document database 114. Other important data is included such as the identity of the parties to the document, the identity of the official user inserting the official document 101 into the official document database 114 and blockchain 112, and the date and time of the insertion of the official document 101.

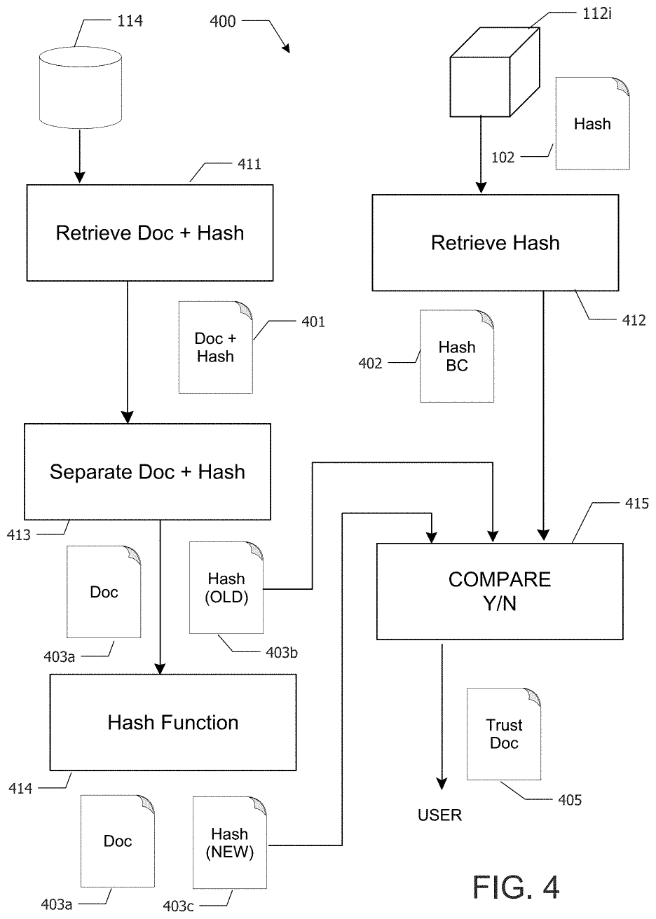

FIG. 4 illustrates an example embodiment of a document and information data flow in a system providing blockchain data storage and transmission of official records and documents according to the present invention. An official document 101 is retrieved when a user searches the official document database 114 and identifies a particular official document 101 to be retrieved. The request to retrieve the official document 101 is sent to a retrieve document+ hash function 411 and a retrieve blockchain hash function 412. The retrieve document+ hash function 411 retrieves the retrieved document+ hash data file 401 from the official document database 114 and passes it to the extract document+hash function 413. The extract document+ hash function 413 extracts the extracted document 403a and extracted hash 403b from the retrieved document+ hash data file 401. The extracted document 403a is passed to the hash function 414 to generate a calculated hash 403c corresponding to the extracted document 403a. The extracted hash 403b and the calculated hash 403c are passed to a compare hash values function 415.

When the retrieve blockchain hash function 412 receives the retrieval request for the official document 101, the retrieve blockchain hash function 412 searches the blockchain 112 and retrieves the retrieved block chain hash 402 stored therein. The retrieve blockchain hash function 412 passes the retrieved block chain hash 402 to the compare hash values function 415 as well.

The compare hash values function 415 compares the retrieved block chain hash 402, extracted hash 403b, and the calculated hash 403c to determine whether or not they match. If these hash values are identical, the extracted document 403a may be considered a trusted document 405 that may be returned to the user requesting the document along with an indication that the trusted document 405 is an accurate and unchanged version of the official document 101. What if the hash values are not identical?

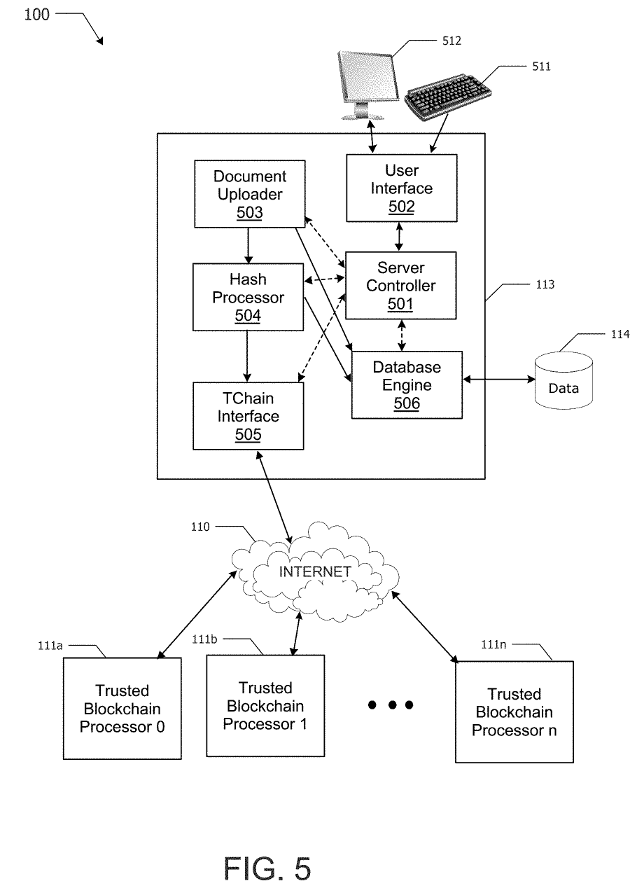

FIG. 5 illustrates a computing system of software components providing blockchain data retrieval of official records and documents according to the present invention. according to the present invention. The official document server 113 comprises a server controller 501, a user interface 502, a document uploader 503, a hash processor 504, a blockchain interface 505, and a database engine 506. The server controller 501 receives the official document 101 via the document uploader 503 in response to user commands from a user using the user interface 502. The server controller 501 also generates a hash value for the official document 101 to be saved into the official document database 114 along with the official document 101. The official document 101 and hash of the official document 102 are sent to the blockchain interface 505 for forwarding to each of the blockchain node processors 111 in the blockchain 112 for adding to the secure block chain The server controller 501 receives input from the user using an input device such as keyboard 511. The server controller 501 also sends messages and data to the user for viewing by a monitor 512. Finally, the server controller 501 performs similar functions as when the official document 101 is retrieved from the official document database 114 as explained in FIG. 4.

The user interface 502 provides input and output processing to provide a user with input and display screens, messages, and data needed to perform the official document 101 insertion and retrieval from the official document database 114 functions. This interface module 502 also accepts commands from the user to instruct the official document server 113 to perform these tasks.

The document uploader 503 accepts digital representations of official documents 101 that are to be stored in the official document database 114. The document uploader 503 forwards the uploaded official document 101 to the hash processor 504 to generate a hash value used by the official document database 114 and the blockchain node processors 111 to store data for later retrieval.

The hash processor 504 implements the hash function that is used to generate the hash values used when an official document 101 is stored and retrieved from the official document database 114. The hash processor 504 accepts any size data block and applies the hash function to calculate a corresponding hash value. The blockchain interface 505 may perform the hash function for any interconnected processing element in the official document server 113.

The blockchain interface 505 permits the official document server 113 to communicate with the blockchain node processors 111 to store and retrieve data from the blockchain 112. The blockchain interface 505 performs all of the data formatting, computer to computer communications, encryption processing, and all similar operations needed by the official document server 113 to communicate with the blockchain node processors 111.

The database engine 506 processes all database operations for the official document database 114. These operations include insertion of official documents 101 into the official document database 114, deletion of official documents 101 from the official document database 114, searching and retrieving 101 data from the official document database 114, and indexing the official document database 114 to maintain efficient searching when needed.

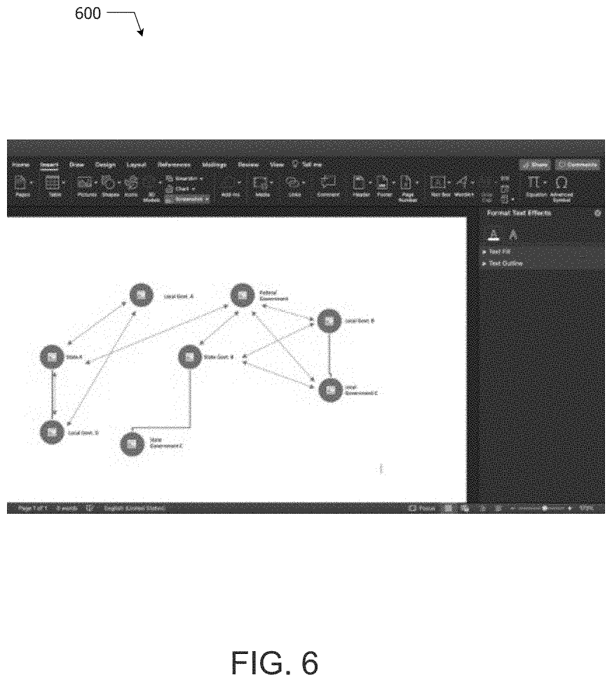

FIG. 6 illustrates a data flow and interconnected blockchain corresponding to software components system providing blockchain data retrieval of official records and documents according to the present invention.

As shown in FIG. 6, the state and local governments can interact with one another and/or interact with the federal government. This would be useful so that all levels of government could see the outflows of money real-time. It would also allow for improvements in state and local contracting practices as local governments of a similar size could see how funds are allocated and reflect on local practices.

In addition, auditors can share information with all users interested in a certain type of spending, and provide assessments of program usefulness/effectiveness and see best practices used in similar communities.

For social services, there would be an automatic verification of services provided to a client without providing the full records. This process may be tracked via an identifier that is detached from the personal information of the client. The receiving social services agency, typically located in another locality within a state or outside of the state, can assess the person for services according to their own local criteria. This would decrease gaps in services as people moved from one locality to another, as many people living in poverty do, and it would allow for the receiving agency to have control over the services that are provided to the person seeking assistance and assess the person according to local criteria.

Local governments could also certify local manufacturing/production of products with government certifying that businesses within a supply chain are taxpaying entities in that country, state, region, or city.

Compilation of data over a number of years would lead to government savings by increasing the effectiveness of contracting at the state and local levels, identifying fraud earlier, providing real-time information about expenditures and income and determining local need. Eventually, there could be real-time statistics about population and workforce.

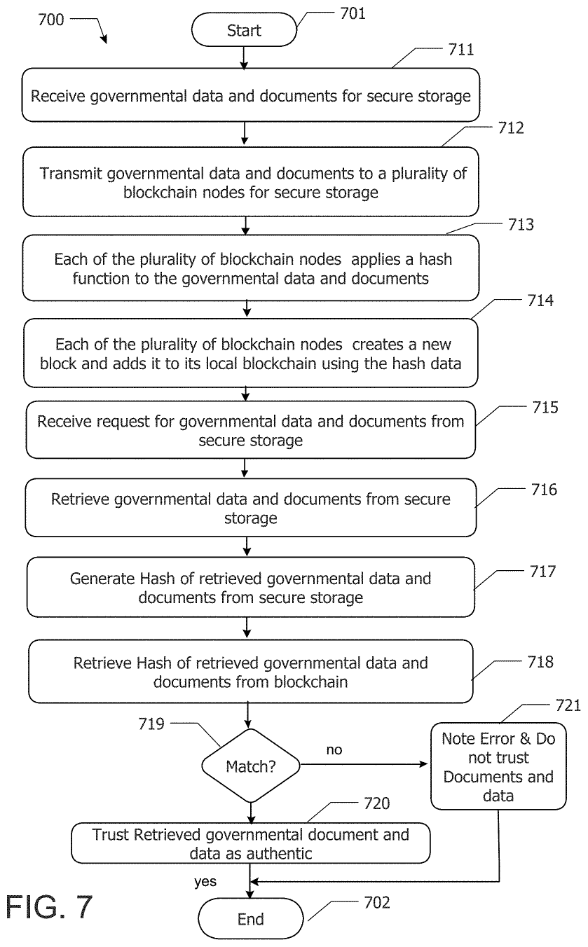

FIG. 7 illustrates a flowchart corresponding to a method performed by a software components system providing blockchain data retrieval of official records and documents according to the present invention. The process 700 begins when governmental documents and data are received for long-term secure storage in step 711. Step 712 transmits the governmental documents and data to a plurality of blockchain nodes and each of the block chain nodes generate a hash for the governmental documents and data in step 713 and stores the hash into a block of its blockchain in step 714.

When a requests for governmental documents and data is received in step 715, a copy of the governmental document and data is retrieved in step 716. A hash is determined for the retrieved copy of the governmental documents and data in step 717. The hash generated when the governmental documents and data was added to the blockchain is retrieved from one or more of the blockchain nodes in step 718.

Test step 719 determines whether the one or more hash values all match the hash generated from the retrieved governmental documents and data. When test step 719 determines that all of the hash values match, the retrieved governmental documents and data are returned to the requesting party with an authentication indication trust the retrieved governmental documents and data in step 720; otherwise an error is noted and provided the notice to the requesting party in step 721 that the retrieved documents and data cannot be trusted.

With the invention, the operator may also have the option to be notified of some or all content that is being selected or uploaded by the users, and these pending images/contents or uploaded images/contents may be viewed by the operator(s) who then may remove or delete any content at any time and/or send messages to users by any means as above. The embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise. Any singular term used in this present patent application is applicable to its plural form even if the singular form of any term is used.

In the present application, all or any part of the invention's software or application(s) or smart device application(s) may be installed on any of the user's or operator's smart device(s), any server(s) or computer system(s) or web application(s) required to allow communication, control, and transfer of content(s) or data between any combination of the components

What is claimed:

1. A system for providing secure and trusted data storage and transmission of documents and data, the system comprising:
a plurality of trusted blockchain processors commutatively connected over the Internet;
one or more document servers for maintaining copies of documents and data commutatively connected to the plurality of trusted blockchain processors; and
data storage coupled to the one or more document servers for storing documents, data, and hash values associated with the documents and data.

2. The system according to claim 1. wherein the one or more document servers comprises:
a memory having instructions stored thereon; and
a processor configured to execute the instructions on the memory to cause the document servers to:
receive a digital representation of documents and data for secure storage and transmission;
transmit a copy of the digital representation of documents and data to the plurality of trusted blockchain processors;
calculate a new hash value associated with the digital representation of documents and data and a last generated hash value from a previous block of data stored into the data storage;
when the new hash value matches a new blockchain hash value generated by a majority of the plurality of block chain processors, store the digital representation of the documents and data along with the new hash value into a block data in the data storage;
wherein the new hash value is used as the last generated hash value for a next block of data and documents to be stored once the digital representation of the documents and data are stored into the data storage.

3. The system according to claim 2, wherein the processor in the one or more document servers further executed instructions causing the document servers to :
receive a request to retrieve a previously stored block of data;
retrieve the previously stored block of data from the data storage;
parse the digital representation of the documents and data and the stored hash value associated with the previously stored block;
transmit the previously stored block of data to the plurality of blockchain processors for generating a retrieved hash value using the documents and data and the last generated hash value from storage in each of the plurality of blockchain processors used when the retrieved block of data was stored;
generate newly generated has value using the documents and data and the last generated hash value from the previous block of data stored immediately before the retrieved block of data was stored; and
indicate that the digital representation of the documents and data from the retrieved block of data when the newly generated hash value, the stored hash value, and a majority of retrieved hash values from the plurality of blockchain processors.

4. The system according to claim 1. wherein the plurality of blockchain processors comprise:
a memory having instructions stored thereon; and
a processor configured to execute the instructions on the memory to cause the document servers to:
receive the digital representation of the documents and data;
retrieve a last generated blockchain hash value form its local storage;
generate a new blockchain hash value using the digital representation of the documents and data and the last generated blockchain hash value; and
store the new blockchain hash value onto the local storage and set it as the last generated blockchain hash value when the new blockchain hash value matches the new hash value generated by the document server and a majority of new blockchain hash values from the other blockchain processor.

5. The system according to claim 4, wherein the processor in the plurality of blockchain processor further executed instructions causing the blockchain processor to:
receive, from the document servers, a previously stored block of data by each of the plurality of blockchain processors for generating a retrieved hash value using the documents and data and the last generated hash value from storage in each of the plurality of blockchain processors used when the retrieved block of data was stored; and
retrieve the stored hash value associated with the retrieved block of data block of data and the stored last used hash value used in generating its hash value from local data storage.

6. The system according to claim 2, the hash function used by the one or more processor servers and the plurality of blockchain processors is the Ethereum hash function.

7. A method for providing secure and trusted data storage and transmission of documents and data using a distributed processing system, the distributed processing system having a plurality of trusted blockchain processors commutatively connected over the Internet, one or more document servers for maintaining copies of documents and data commutatively connected to the plurality of trusted blockchain processors, and data storage coupled to the one or more document servers for storing documents, data, and hash values associated with the documents and data, the method comprising:
receiving a digital representation of documents and data for secure storage and transmission;
transmitting a copy of the digital representation of documents and data to the plurality of trusted blockchain processors;
calculating a new hash value associated with the digital representation of documents and data and a last generated hash value from a previous block of data stored into the data storage; and
when the new hash value matches a new blockchain hash value generated by a majority of the plurality of block chain processors, storing the digital representation of the documents and data along with the new hash value into a block data in the data storage;
wherein the new hash value is used as the last generated hash value for a next block of data and documents to be stored once the digital representation of the documents and data are stored into the data storage.

8. The method according to claim 7, wherein the method further comprising:
receiving a request to retrieve a previously stored block of data by one or more of the document servers;
retrieving the previously stored block of data from the data storage by one or more of the document servers;
parsing the digital representation of the documents and data and the stored hash value associated with the previously stored block by one or more of the document servers;
transmitting the previously stored block of data to the plurality of blockchain processors for generating a retrieved hash value using the documents and data and the last generated hash value from storage in each of the plurality of blockchain processors used when the retrieved block of data was stored by one or more of the document servers;
generating, by one or more of the document servers, a newly generated has value using the documents and data and the last generated hash value from the previous block of data stored immediately before the retrieved block of data was stored; and
indicating, by one or more of the document servers, that the digital representation of the documents and data from the retrieved block of data when the newly generated hash value, the stored hash value, and a majority of retrieved hash values from the plurality of blockchain processors.

9. The method according to claim 7, wherein the method further comprising:
receiving, by the plurality of blockchain processors, the digital representation of the documents and data;
retrieving a last generated blockchain hash value form its local storage by the plurality of blockchain processors;
generating a new blockchain hash value using the digital representation of the documents and data and the last generated blockchain hash value by the plurality of blockchain processors; and
storing the new blockchain hash value onto the local storage and set it as the last generated blockchain hash value when the new blockchain hash value matches the new hash value generated by the document server and a majority of new blockchain hash values from the other blockchain processor.

10. The method according to claim 9, wherein the method further comprising:
receiving, from the document servers, a previously stored block of data by each of the plurality of blockchain processors for generating a retrieved hash value using the documents and data and the last generated hash value from storage in each of the plurality of blockchain processors used when the retrieved block of data was stored; and
retrieving the stored hash value associated with the retrieved block of data block of data and the stored last used hash value used in generating its hash value from local data storage.
